(19) United States
(12) Patent Application Publication
(10) Pub. No.: US 2007/0189392 A1
(43) Pub. Date: Aug. 16, 2007

(54) Reduced resolution update mode for advanced video coding

(76) Inventors: Alexandros Tourapis, Santa Clara, CA (US); Jill Macdonald Boyce, Manalapan, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/591,939

(22) PCT Filed: Mar. 1, 2005
(86) PCT No.: PCT/US05/06453

§ 371 Date: Sep. 7, 2006

Related U.S. Application Data
(60) Provisional application No. 60/551,417, filed on Mar. 9, 2004.

(51) Int. Cl. H04N 11/02; H04B 1/66

(52) U.S. Cl. 375/240.21; 375/240.27

(57) ABSTRACT

There is provided a video encoder, video decoder and corresponding encoding and decoding methods for respectively encoding and decoding video signal data for an image slice. The video encoder includes a slice prediction residual downsampler for downsampling a prediction residual of at least a portion of the image slice prior to transformation and quantization of the prediction residual. The video decoder includes a prediction residual upsampler for upsampling a prediction residual of the image slice.

### CROSS-REFERENCE TO RELATED APPLICATIONS

This application claims the benefit of U.S. Provisional Application Ser. No. 60/551,417 (Attorney Docket No. PU040073), filed Mar. 9, 2004 and entitled “REDUCED RESOLUTION SLICE UPDATE MODE FOR ADVANCED VIDEO CODING”, which is incorporated by reference herein in its entirety.

### GOVERNMENT LICENSE RIGHTS IN FEDERALLY SPONSORED RESEARCH AND DEVELOPMENT

The U.S. Government has a paid-up license in this invention and the right in limited circumstances to require the patent owner to license others on reasonable terms as provided for by the terms of project ID contract No. 2003005676B awarded by the National Institute of Standards and Technology.

### FIELD OF THE INVENTION

The present invention generally relates to video coders and decoders and, more particularly, to a reduced resolution slice update mode for advanced video coding.

### BACKGROUND OF THE INVENTION

The International Telecommunication Union, Telecommunication Sector (ITU-T) H.264 (or Joint Video Team (JVT), or Moving Picture Experts Group (“MPEG”)-4 Advanced Video Coding (AVC)) standard has introduced several new features that allows it to achieve considerable improvement in coding efficiency when compared to older standards such as MPEG-2/4, and H.263. Nevertheless, although H.264 includes most of the algorithmic features of older standards, some features were were abandoned and/or never ported. One of these features was the consideration of the Reduced-Resolution Update mode that already exists within H.263. This mode provides the opportunity to increase the coding picture rate, while maintaining sufficient subjective quality. This is done by encoding an image at a reduced resolution, while performing prediction using a high resolution reference, which also allows the final image to be reconstructed at full resolution. This mode was found useful in H.263 especially during the presence of heavy motion within the sequence since it allowed an encoder to maintain a high frame rate (and thus improved temporal resolution) while also maintaining high resolution and quality in stationary areas.

Although the syntax of a bitstream encoded in this mode was essentially identical to a bitstream coded in full resolution, the main difference was on how all modes within the bitstream were interpreted, and how the residual information was considered and added after motion compensation. More specifically, an image in this mode had ¼ the number of macroblocks compared to a full resolution coded picture, while motion vector data was associated with block sizes of 32×32 and 16×16 of the full resolution picture instead of 16×16 and 8×8, respectively. On the other hand, Discrete Cosine Transform (DCT) and texture data are associated with 8×8 blocks of a reduced resolution image, while an upsampling process is required in order to generate the final full image representation.

Although this process could result in a reduction in objective quality, this is more than compensated from the reduction of bits that need to be encoded due to the reduced number (by 4) of modes, motion data, and residuals. This is especially important at very low bitrates where modes and motion data can be considerably more than the residual. Subjective quality was also far less impaired compared to objective quality. Also, this process can be seen somewhat similar to the application of a low pass filter on the residual data prior to encoding, which, however, requires the transmission of all modes, motion data, and filtered residuals, thus being less efficient. This concept was never introduced within H.264 and therefore is not supported in concept, methodology, or syntax.

### SUMMARY OF THE INVENTION

These and other drawbacks and disadvantages of the prior art are addressed by the present invention, which is directed to developing and supporting a reduced resolution slice update mode for advanced video coding. The reduced resolution slice update mode disclosed herein is particularly suited for use with, but is not limited to, H.264 (or JVT, or MPEG-4 AVC).

According to an aspect of the present invention, there is provided a video encoder for encoding video signal data for an image slice. The video encoder includes a slice prediction residual downsampler for downsampling a prediction residual of at least a portion of the image slice prior to transformation and quantization of the prediction residual.

According to another aspect of the present invention, there is provided a video encoder for encoding video signal data for an image. The video encoder includes macroblock ordering means and a slice prediction residual downsampler. The macroblock ordering means is for arranging macroblocks corresponding to the image into two or more slice groups. The slice prediction residual downsampler is for downsampling a prediction residual of at least a portion of an image slice prior to transformation and quantization of the prediction residual. The slice prediction residual downsampler is further for receiving at least one of the two or more slice groups for downsampling.

According to still another aspect of the present invention, there is provided a video decoder for decoding video signal data for an image slice. The video decoder includes a prediction residual upsampler for upsampling a prediction residual of the image slice, and an adder for adding the upsampled prediction residual to a predicted reference.

According to yet another aspect of the present invention, there is provided a method for encoding video signal data for an image slice, the method comprising the step of downsampling a prediction residual of the image slice prior to transformation and quantization of the prediction residual.

According to still yet another aspect of the present invention, there is provided a method for decoding video signal data for an image slice. The method includes the steps of upsampling a prediction residual of the image slice, and adding the upsampled prediction residual to a predicted reference.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 shows a diagram for exemplary macroblock and sub-macroblock partitions in a Reduced Resolution Update (RRU) mode for H.264 in accordance with the principles of the present invention;

FIG. 2 shows a diagram for exemplary samples used for 8×8 intra prediction in accordance with the principles of the present invention;

FIGS. 3A and 3B show diagrams for an exemplary residual upsampling process for block boundaries and for inner positions, respectively, in accordance with the principles of the present invention;

FIGS. 4A and 4B show diagrams for motion inheritance for direct mode if the current slice is in reduced resolution and the first list1 reference is in full resolution when direct_{—}8×8_inference_flag is set to 0 and is set to 1, respectively;

FIG. 5 shows a diagram for resolution extension for a Quarter Common Intermediate Format (QCIF) resolution picture in accordance with the principles of the present invention;

FIG. 6 shows a block diagram for an exemplary video encoder in accordance with the principles of the present invention;

FIG. 7 shows a block diagram for an exemplary video decoder in accordance with the principles of the present invention;

FIG. 8 shows a flow diagram for an exemplary encoding process in accordance with the principles of the present invention; and

FIG. 9 shows a flow diagram for an exemplary decoding process in accordance with the principles of the present invention.

### DETAILED DESCRIPTION OF PREFERRED EMBODIMENTS

The present invention is directed to a reduced resolution slice update mode for advanced video coding. The present invention utilizes the concept of a Reduced Resolution Update (RRU) Mode, currently supported by the ITU-T H.263 standard, and allows for an RRU Mode to be introduced and used within the new ITU-T H.264 (MPEG-4 AVC/JVT) video coding standard. This mode provides the opportunity to increase the coding picture rate, while maintaining sufficient subjective quality. This is done by encoding an image at a reduced resolution, while performing prediction using a high resolution reference. This allows the final image to be reconstructed at full resolution and with good quality, although the bitrate required to encode the image has been reduced considerably. Considering that H.264 does not support the RRU mode, the present invention utilizes several new and unique tools and concepts to implement it's RRU. For example, in developing RRU for H.264, the concept had to be modified to fit within the specifications of the new standard and/or its extensions. This includes new syntax elements, and certain semantic and encoder/decoder architecture modifications to inter and intra prediction modes. The impacts on other tools/features that are supported by the H.264 standard, such as Macroblock Based Adaptive Field/Frame mode, are also described and addressed herein.

The instant description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means that can provide those functionalities as equivalent to those shown herein.

Advantageously, the present invention provides an apparatus and method for implementing a Reduced-Resolution Update (RRU) mode within H.264. Certain aspects of the CODEC regarding this new mode need to be considered. Specifically, it is necessary to develop a new slice parameter (reduced_resolution_update) according to which the current slice is subdivided into (RRUwidth*16)×(RRUheight*16) size macroblocks. Unlike in H.263, it is not necessary that RRUwidth be equal to RRUheight. Additional slice parameters can be included, more specifically rru_width_scale=RRUwidth and rru_height_scale=RRUheight which allows for the reduction of resolution horizontally or vertically at any desired ratio. Table 11 presents H.264 slice header syntax with consideration of Reduced Resolution Update (RRU), in accordance with the principles of the present invention.

Possible options, for example, include scaling by 1 horizontally & 2 vertically (macroblocks (MBs) are of size 16×32), 2 vertically & 1 horizontally (MB size 32×16), or in general have MBs of size (rru_width_scale*16)×(rru_height_scale*16).

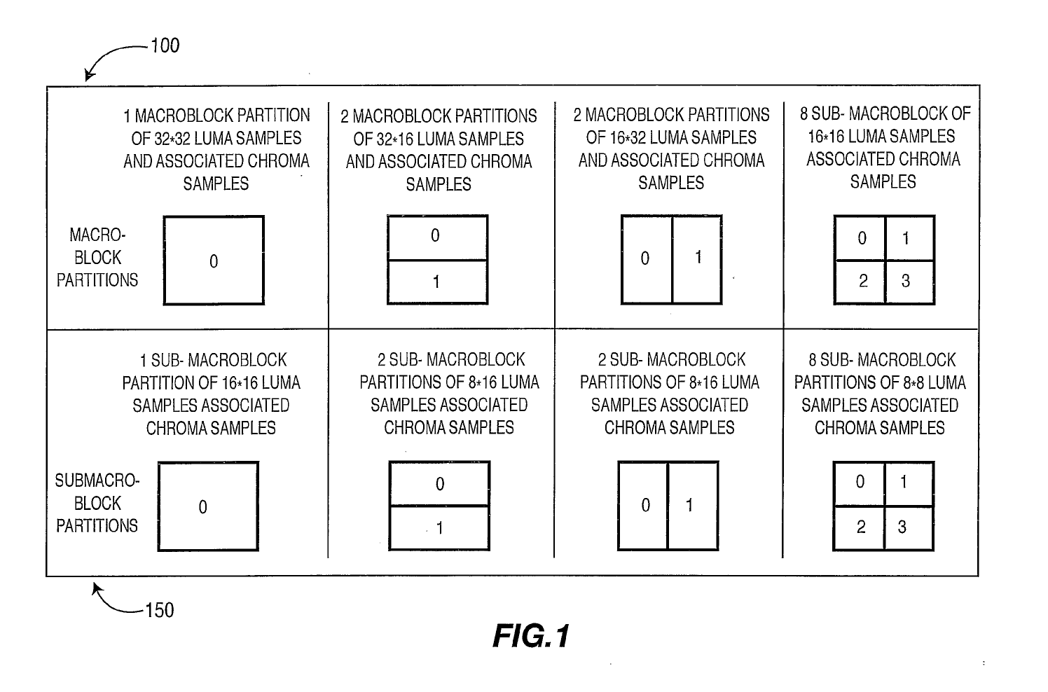

Without loss in generality, the case is discussed where RRUwidth=RRUheight=2 and the macroblocks are of size 32×32. In this case, all macroblock partitions and sub-partitions have to be scaled by 2 horizontally and 2 vertically. FIG. 1 shows a diagram for exemplary macroblock partitions 100 and sub-macroblock partitions 150 in a Reduced Resolution Update (RRU) mode for H.264 in accordance with the principles of the present invention. Unlike H.263 where motion vector data had to be divided by 2 to conform to the standards specifics, this is not necessary in H.264 and motion vector data can be coded in full resolution/subpel accuracy. Skipped macroblocks in P slices are in this mode considered as having 32×32 size, while the process for computing their associated motion data remains unchanged, although 32×32 neighbors need to now be considered instead of 16×16 neighbors.

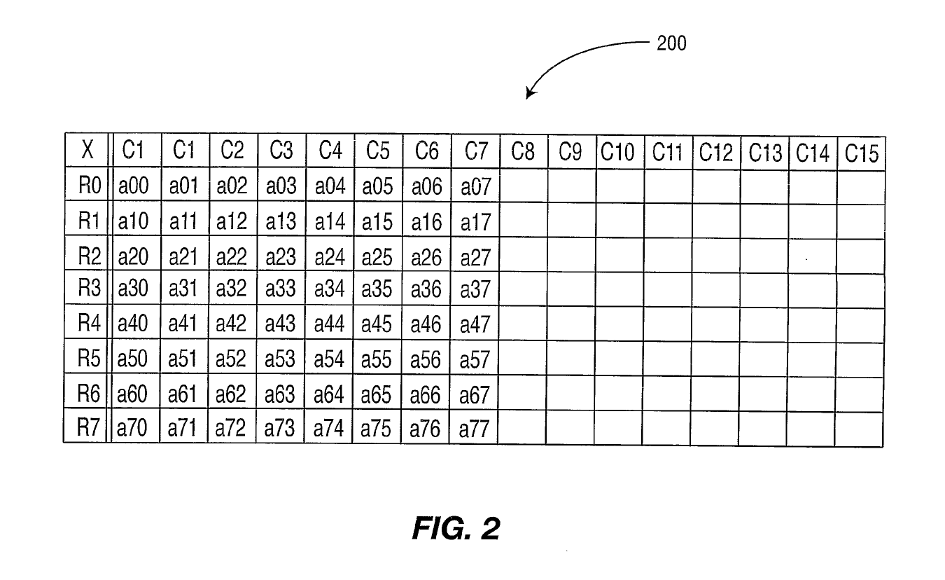

Another key difference of this invention, although optional, is that in H.264, texture data does not have to represent information from a lower resolution image. Since intra coding in H.264 is performed through the consideration of spatial prediction methods using either 4×4 or 16×16 block sizes, this can be extended, similarly to inter prediction modes, to 8×8 and 32×32 intra prediction block sizes. Prediction modes nevertheless remain more or less the same, although now more samples are used to generate the prediction signal. FIG. 2 shows a diagram for exemplary samples 200 used for 8×8 intra prediction in accordance with the principles of the present invention. The samples 200 include samples C0-C15, X, and R0-R7. For example, for 8×8 vertical prediction, samples C0-C7 are now used, while DC prediction is the mean of C0-C7 and R0-R7. Furthermore, all diagonal predictions need to also consider samples C8-C15. A similar extension can be applied to the 32×32 intra prediction mode.

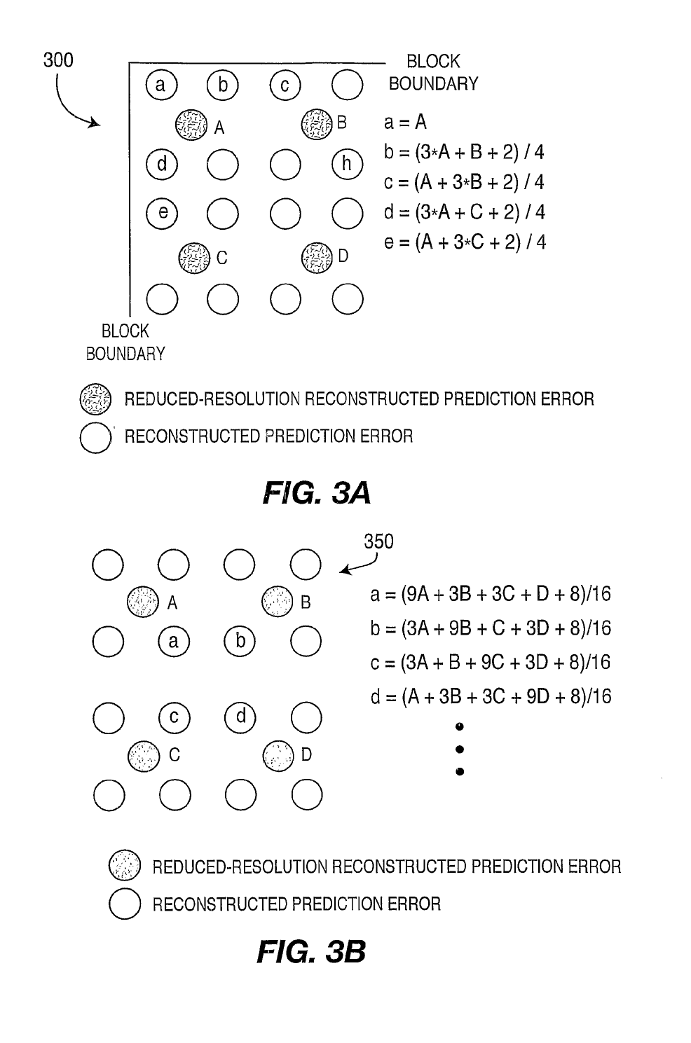

The residual data is then downsampled and is coded using the same transform and quantization process already available in H.264. The same process is applied for both Luma and Chroma samples. During decoding the residual data needs to be upsampled. The downsampling process is done only in the encoder, and hence does not need to be standardized. The upsampling process must be matched in the encoder and the decoder, and so must be standardized. Possible upsampling methods that could be used include, but are not limited to, zero or first order hold or by considering a similar strategy as in H.263. FIGS. 3A and 3B show diagrams for an exemplary residual upsampling processes 300 and 350 for block boundaries and for inner positions, respectively, in accordance with the principles of the present invention. In FIG. 3a, the upsampling process on block edges uses only samples inside the block boundaries to compute the upsampled values. In FIG. 3b, inside the interior of the block, all of the nearest neighbor positions are available, so an interpolation based on relative positioning of the sample, e.g. bilinear interpolation in two dimensions, is used to compute the upsampled values.

H.264 also considers an in-loop deblocking filter, applied to 4×4 block edges. Since currently the prediction process is now applied to block sizes of 8×8 and above, this process is also modified to consider 8×8 block edges instead. However, it is to be appreciated that, given the teachings of the present invention provided herein, one of ordinary skill in the related art will contemplate these and other sizes for block edges employed in accordance with the principles of the present invention, while maintaining the spirit of the present invention.

Different slices in the same picture may have different values of reduced_resolution_update, rru_width_scale and rru_height_scale. Since the in-loop deblocking filter is applied across slice boundaries, blocks on either side of the slice boundary may have been coded at different resolutions. In this case, for the deblocking filter parameters computation, the following is to be considered: the largest Quantization Parameter (QP) value among the two neighboring 4×4 normal blocks on a given 8×8 edge, while the strength of the deblocking is now based on the total number of non-zero coefficients of the two blocks.

To support Flexible Macroblock Ordering (FMO) as indicated by num_slice_groups_minus1 greater than 0 in the picture parameter sets, with Reduced Resolution Update mode, it is also necessary to transmit in the picture parameter set an additional parameter named reduced_resolution_update_enable. Table 10 presents H.264 picture parameter syntax with consideration of Reduced Resolution Update (RRU), in accordance with the principles of the present invention. It is not allowed to encode a slice using the Reduced Resolution Mode if FMO is present and this parameter is not set. Furthermore, if this parameter is set, the parameters rru_max_width_scale and rru_max_height_scale also need to be transmitted. These parameters are necessary to ensure that the map provided can always support the current Reduced Resolution macroblock size. This means that it is necessary for these parameters to conform to the following conditions:
max_width_scale % rru_width_scale=0,
max_height_scale % rru_height_scale=0 and,
max_width_scale>0, max_height_scale>0.

The FMO slice group map that is transmitted corresponds to the lowest allowed reduced resolution, corresponding to rru_max_width_scale and rru_max_height_scale. Note that if multiple macroblock resolutions are used, then rru_max_width_scale and rru_max_height_scale need to be multiples of the least common multiple of all possible resolutions within the same picture.

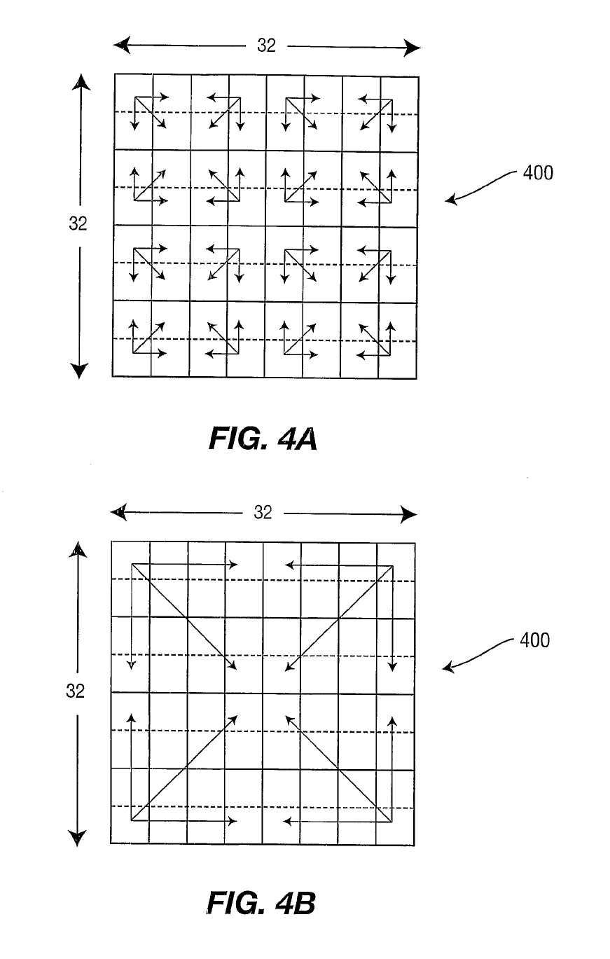

Direct modes in H.264 are affected depending on whether the current slice is in reduced resolution mode, or the list1 reference is in reduced resolution mode and the current one is not in reduced resolution mode. For the direct mode case, when the current picture is in reduced resolution and the reference picture is of full resolution, a similar method currently employed within H.264 is borrowed from when the direct_{—}8×8_inference_flag is enabled. According to this method, co-located partitions are assigned by considering only the corresponding corner 4×4 blocks (corner is based on block indices) of an 8×8 partition. In our case, if direct belongs to a reduced resolution slice, motion data for the co-located partition are derived as if direct_{—}8×8_inference_flag was set to 1. This can be seen also as a downsampling of the motion field of the co-located reference. Although not necessary, if the direct_{—}8×8_inference_flag was already set within the bitstream, this process could be applied twice. This process can be seen more clearly in FIGS. 4A and 4B, which show diagrams for motion inheritance 400 for direct mode if the current slice is in reduced resolution and the first list1 reference is in full resolution when direct_{—}8×8_inference_flag is set to 0 and is set to 1, respectively. For the case when the current slice is not in reduced resolution mode, but its first list1 reference is in reduced resolution mode, it is necessary to first upsample all motion data of this reduced resolution reference. Motion data can be upsampled using zero order hold, which is the method with the least complexity. Other filtering methods, for example similar to the process used for the upsampling of the residual data, could also be used.

Some other tools of H.264 are also affected through the consideration of this mode. More specifically, macroblock adaptive field frame mode (MB-AFF) needs to be now considered using a 32×64 super-macroblock structure. The upsampling process is performed on individual coded block residuals. If field pictures are coded, then the blocks are coded as field residuals, and hence the upsampling is done in fields. Similarly, when MB-AFF is used, individual blocks are coded either in field or frame mode, and their corresponding residuals are upsampled in field or frame mode respectively.

To allow the reduced resolution mode to work for all possible resolutions, a picture is always extended vertically and horizontally in order to be always divisible by 16*rru_height_scale and 16 *rru_width_scale, respectively. For the example where rru_height_scale=rru_width_scale=2, the original resolution of an image was HR×VR the image is padded to a resolution equal to Hc×Vc where:
H_{c}=((H_{R}+31)/32)*32
V_{c}=((V_{R}+31)/32)*32

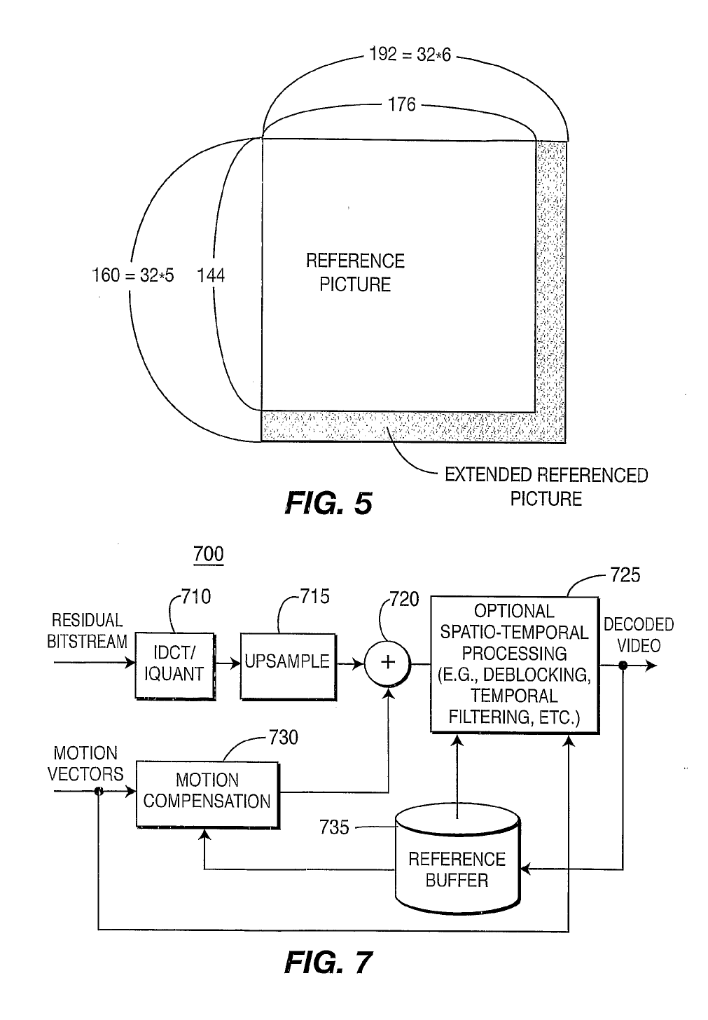

The process for extending the image resolution is similar to what is currently done for H.264 to extend the picture size to be divisible by 16. FIG. 5 shows a diagram for resolution extension for a Quarter Common Intermediate Format (QCIF) resolution picture 500 in accordance with the principles of the present invention.

The extended luminance for a QCIF resolution picture is given by the following formula:

$$\begin{matrix}{R}_{RRU} ( x , y ) = R ( {x}^{′} , {y}^{′} ) , \\ where \\ x , y = spatial coordinates of the extended \\ referenced picture in the Pixel domain , \\ {x}^{′} , {y}^{′} = spatial coordinates of the referenced \\ picture in the pixel domain , \\ {R}_{RRU} ( x , y ) = pixel value of the extended referenced picture at ( x , y ) , \\ R ( {x}^{′} , {y}^{′} ) = pixel value of the referenced picture at ( {x}^{′} , {y}^{′} ) \\ {x}^{′} = 175 if x > 175 and x < 192 \\ = x otherwise , \\ {y}^{′} = 143 if y > 143 and y < 160 \\ = y otherwise ,\end{matrix}$$

A similar approach is used for extending chroma samples, but to half of the size.

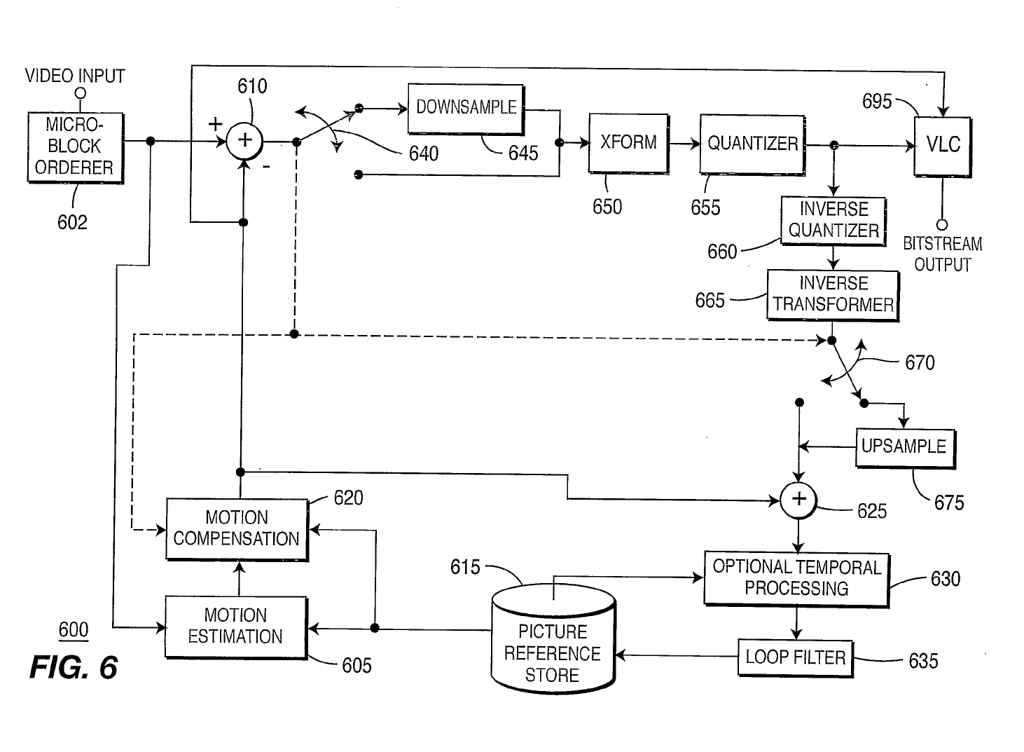

Turning to FIG. 6, an exemplary video encoder is indicated generally by the reference numeral 600. A video input to the encoder 600 is coupled in signal communication with an input of a macroblock orderer 602. An output of the macroblock orderer 602 is coupled in signal communication with a first input of a motion estimator 605 and with a first input (non-inverting) of a first adder 610. A second input of the motion estimator 605 is coupled in signal communication with an output of a picture reference store 615. An output of the motion estimator 605 is coupled in signal communication with a first input of a motion compensator 620. A second input of the motion compensator 620 is coupled in signal communication with the output of the picture reference store 615. An output of the motion compensator is coupled in signal communication with a second input (inverting) of the first adder 610, with a first input (non-inverting) of a second adder 625, and with a first input of a variable length coder (VLC) 695. An output of the second adder 625 is coupled in signal communication with a first input of an optional temporal processor 630. A second input of the optional temporal processor 630 is coupled in signal communication with another output of the picture reference store 615. An output of the optional temporal processor 630 is coupled in signal communication with an input of a loop filter 635. An output of the loop filter 635 is coupled in signal communication with an input of the picture reference store 615.

An output of the first adder 610 is coupled in signal communication with an input of a first switch 640. An output of the first switch 640 is capable of being coupled in signal communication with an input of a downsampler 645 or with an input of a transformer 650. An output of the downsampler 645 is coupled in signal communication with the input of the transformer 650. An output of the transformer 650 is coupled in signal communication with an input of a quantizer 655. An output of the quantizer 655 is coupled in signal communication with an input of the variable length coder 695 and with an input of an inverse quantizer 660. An output of the inverse quantizer 660 is coupled in signal communication with an input of an inverse transformer 665. An output of the inverse transformer 665 is coupled in signal communication with an input of a second switch 670. An output of the second switch 670 is capable of being coupled in signal communication with a second input of the second adder 625 or with an input of an upsampler 675. An output of the upsampler is coupled in signal communication with the second input of the second adder 625. An output of the variable length coder 695 is coupled to an output of the encoder 600. It is to be noted that when the first switch 640 and the second switch 670 are coupled in signal communication with the downsampler 645 and the upsampler 675, respectively, a signal path is formed from the output of the first adder 610 to a third input of the motion compensator 620 and to the input of the upsampler 675. It is to be appreciated that first switch 640 may include RRU mode determining means for determining an RRU mode. The macroblock orderer 602 arranges macroblocks of a given image into slice groups.

Turning to FIG. 7, an exemplary video decoder is indicated generally by the reference numeral 700. A first input of the decoder 700 is coupled in signal communication with an input of an inverse transformer/quantizer 710. An output of the inverse transformer/quantizer 710 is coupled in signal communication with an input of an upsampler 715. An output of the upsampler 715 is coupled in signal communication with a first input of an adder 720. An output of the adder 720 is coupled in signal communication with an optional spatio-temporal processor 725. An output of the spatio-temporal processor is coupled in signal communication with an output of the decoder 700. In the case that the spatio-temporal processor 725 is not employed, the output of the decoder 700 is taken from the output of the adder 720.

A second input of the decoder 700 is coupled in signal communication with a first input of a motion compensator 730. An output of the motion compensator 730 is coupled in signal communication with a second input of the adder 720. The adder 720 is used to combine the unsampled prediction residual with a predicted reference. A second input of the motion compensator 730 is coupled in signal communication with a first output of a reference buffer 735. A second output of the reference buffer 735 is coupled in signal communication with the spatio-temporal processor 725. The input to the reference buffer 735 is the decoder output. The inverse transformer/quantizer 710 inputs a residual bitstream and outputs a decoded residue. The reference buffer 735 outputs a reference picture and the motion compensator 730 outputs a motion compensated prediction.

The decoder implementation shown in FIG. 7 can be extended and improved by using additional processing elements, such as spatio-temporal analysis in both the encoder and decoder, which would allow us to remove some of the artifacts introduced through the residual downsampling and upsampling process.

A variation of the above approach is to allow the use of reduced resolutions not just at the slice level, but also at the macroblock level. Although there may be different variations of this approach, one approach is to signal resolution variation through the usage of the reference picture indicator. Reference pictures could be associated implicitly (e.g., odd/even references) or explicitly (e.g., through a transmitted table in the slice parameters) with the transmission of full or reduced resolution residual. If a 32×32 macroblock is coded using reduced residual, then a single codedblockpattern (cbp) is associated and transmitted with the transform coefficients of the 16 reduced resolution blocks. Otherwise, 4 cbp (or a single combined one) needs to be transmitted, which are associated with 64 full resolution blocks. Note that for this method to work, all blocks within this macroblock need to be coded in the same resolution. This method requires the transmission of an additional table, which would provide the information regarding the scaling, or not of the current reference, including the scaling parameters, similarly to what is currently done for weighted prediction.

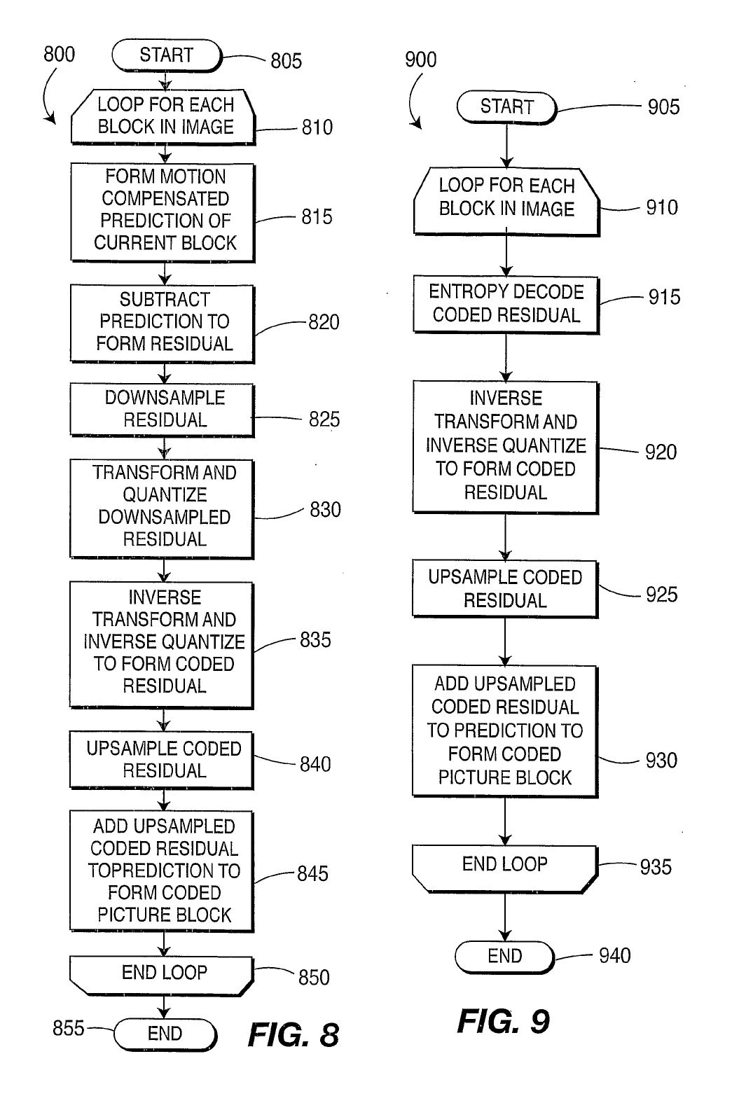

Turning to FIG. 8, an exemplary video encoding process is indicated generally by the reference numeral 800. The process 800 includes a start block 805 that passes control to a loop limit block 810. The loop limit block 810 begins a loop for a current block in an image, and passes control to a function block 815. The function block 815 forms a motion compensated prediction of the current block, and passes control to a function block 820. The function block 820 subtracts the motion compensated prediction from the current macroblock to form a prediction residual, and passes control to a function block 825. The function block 825 downsamples the prediction residual, and passes control to a function block 830. The function block 830 transforms and quantizes the downsampled prediction residual, and passes control to a function block 835. The function block 835 inverse transforms and quantizes the prediction residual to form a coded prediction residual, and passes control to a function block 840. The function block 840 upsamples the coded residual, and passes control to a function block 845. The function block 845 adds the upsampled coded residual to the prediction to form a coded picture block, and passes control to an end loop block 850. The end loop block 850 ends the loop and passes control to an end block 855.

Turning to FIG. 9, an exemplary decoding process is indicated generally by the reference numeral 900. The decoding process 900 includes a start block 905 that passes control to a loop limit block 910. The loop limit block 910 begins a loop for a current block in an image, and passes control to a function block 915. The function block 915 entropy decodes the coded residual, and passes control to a function block 920. The function block 920 inverse transforms and quantizes the decoded residual to form a coded residual, and passes control to a function block 925. The function block 925 upsamples the coded residual, and passes control to a function block 930. The function block 930 adds the upsampled coded residual to the prediction to form a coded picture block, and passes control to a loop limit block 935. The loop limit block 935 ends the loop and passes control to an end block 940.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be coupled to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

TABLE 1

| | | | De- |
|---|---|---|---|
| pic_parameter_set_rbsp( ) { | | C | scriptor |
| | pic_parameter_set_id | 1 | ue(v) |
| | seq_parameter_set_id | 1 | ue(v) |
| | entropy_coding_mode_flag | 1 | u(1) |
| | pic_order_present_flag | 1 | u(1) |
| | num_slice_groups_minus1 | 1 | ue(v) |
| | if( num_slice_groups_minus1 > 0 ) { | | |

/* Consideration of RRU */

| | | |
|---|---|---|
| reduced_resolution_update_enable | 1 | u(1) |
| if( !reduced_resolution_update) { | | |

| | | |
|---|---|---|
| rru_max_width_scale | 1 | u(v) |
| rru_max_height_scale | 1 | u(v) |

}

/* End of Reduced Resolution Update Parameters */

| | | |
|---|---|---|
| slice_group_map_type | 1 | ue(v) |
| if( slice_group_map_type = = 0 ) | | |

for( iGroup = 0; iGroup <=
num_slice_groups_minus1; iGroup++ )

| | | |
|---|---|---|
| run_length_minus1[ iGroup ] | 1 | ue(v) |

else if( slice_group_map_type = = 2 )

for( iGroup = 0; iGroup <
num_slice_groups_minus1; iGroup++ ) {

| | | |
|---|---|---|
| top_left[ iGroup ] | 1 | ue(v) |
| bottom_right[ iGroup ] | 1 | ue(v) |

}

else if( slice_group_map_type = = 3 ||

slice_group_map_type = = 4 ||
slice_group_map_type = = 5 ) {

| | | |
|---|---|---|
| slice_group_change_direction_flag | 1 | u(1) |
| slice_group_change_rate_minus1 | 1 | ue(v) |

} else if( slice_group_map_type = = 6 ) {

| | | |
|---|---|---|
| pic_size_in_map_units_minus1 | 1 | ue(v) |
| for( i = 0; i <= | | |
| pic_size_in_map_units_minus1; i++ ) | | |

| | | |
|---|---|---|
| slice_group_id[ i ] | 1 | u(v) |

}

| } | | |
|---|---|---|
| num_ref_idx_l0_active_minus1 | 1 | ue(v) |
| num_ref_idx_l1_active_minus1 | 1 | ue(v) |
| weighted_pred_flag | 1 | u(1) |
| weighted_bipred_idc | 1 | u(2) |
| pic_init_qp_minus26 /* relative to 26 */ | 1 | se(v) |
| pic_init_qs_minus26 /* relative to 26 */ | 1 | se(v) |
| chroma_qp_index_offset | 1 | se(v) |
| deblocking_filter_control_present_flag | 1 | u(1) |
| constrained_intra_pred_flag | 1 | u(1) |
| redundant_pic_cnt_present_flag | 1 | u(1) |
| rbsp_trailing_bits( ) | 1 | |

}

TABLE 2

| | | | De- |
|---|---|---|---|
| slice_header( ) { | | C | scriptor |
| first_mb_in_slice | | 2 | ue(v) |
| | slice_type | 2 | ue(v) |
| | pic_parameter_set_id | 2 | ue(v) |
| | frame_num | 2 | u(v) |

/* Reduced Resolution Update parameters */

| | | |
|---|---|---|
| reduced_resolution_update | 2 | u(1) |

/* Following is optional*/

if( !reduced_resolution_update) {

| | | |
|---|---|---|
| rru_width_scale | 2 | u(v) |
| rru_height_scale | 2 | u(v) |

}

/* End of Reduced Resolution Update Parameters */

if( !frame_mbs_only_flag ) {

| | | |
|---|---|---|
| field_pic_flag | 2 | u(1) |
| if( field_pic_flag ) | | |

| | | |
|---|---|---|
| bottom_field_flag | 2 | u(1) |

}
if( nal_unit_type = = 5 )

| | | |
|---|---|---|
| idr_pic_id | 2 | ue(v) |

if( pic_order_cnt_type = = 0 ) {

| | | |
|---|---|---|
| pic_order_cnt_lsb | 2 | u(v) |
| if( pic_order_present_flag && | | |
| !field_pic_flag ) | | |

| | | |
|---|---|---|
| delta_pic_order_cnt_bottom | 2 | se(v) |

}
if( pic_order_cnt_type = = 1 &&
!delta_pic_order_always_zero_flag ) {

| | | |
|---|---|---|
| delta_pic_order_cnt[ 0 ] | 2 | se(v) |
| if( pic_order_present_flag && | | |
| !field_pic_flag ) | | |

| | | |
|---|---|---|
| delta_pic_order_cnt[ 1 ] | 2 | se(v) |

}
if( redundant_pic_cnt_present_flag )

| | | |
|---|---|---|
| redundant_pic_cnt | 2 | ue(v) |

if( slice_type = = B )

| | | |
|---|---|---|
| direct_spatial_mv_pred_flag | 2 | u(1) |

if( slice_type = = P || slice_type = = SP ||
slice_type = = B ) {

| | | |
|---|---|---|
| num_ref_idx_active_override_flag | 2 | u(1) |
| if( num_ref_idx_active_override_flag ) { | | |

| | | |
|---|---|---|
| num_ref_idx_l0_active_minus 1 | 2 | ue(v) |
| if( slice_type = = B ) | | |

| | | |
|---|---|---|
| num_ref_idx_l1_active_minus1 | 2 | ue(v) |

}

| } | |
|---|---|
| ref_pic_list_reordering( ) | 2 |
| if( ( weighted_pred_flag && ( slice_type = = P | |
| \|\| slice_type = = SP ) ) \|\| | |

| ( weighted_bipred_idc = = 1 && | |
|---|---|
| slice_type = = B ) ) | |
| pred_weight_table( ) | 2 |

if( nal_ref_idc != 0 )

| | |
|---|---|
| dec_ref_pic_marking( ) | 2 |

if( entropy_coding_mode_flag && slice_type !=
I && slice_type !=

SI)

| | | |
|---|---|---|
| cabac_init_idc | 2 | ue(v) |

| | | |
|---|---|---|
| slice_qp_delta | 2 | se(v) |
| if( slice_type = = SP \|\| slice_type = = SI ) { | | |

if( slice_type = = SP )

| | | |
|---|---|---|
| sp_for_switch_flag | 2 | u(1) |

| | | |
|---|---|---|
| slice_qs_delta | 2 | se(v) |

}
if( deblocking_filter_control_present_flag ) {

| | | |
|---|---|---|
| disable_deblocking_filter_idc | 2 | ue(v) |
| if( disable_deblocking_filter_idc != 1 ) { | | |

| | | |
|---|---|---|
| slice_alpha_c0_offset_div2 | 2 | se(v) |
| slice_beta_offset_div2 | 2 | se(v) |

}

}
if( num_slice_groups_minus1 > 0 &&

| slice_group_map_type >= 3 && | | |
|---|---|---|
| slice_group_map_type <= 5) | | |
| slice_group_change_cycle | 2 | u(v) |

}

1. A video encoder for encoding video signal data for an image slice comprising:
a slice prediction residual downsampler adapted for selective coupling with the input of a transformer;
a quantizer coupled with the output of the transformer; and
an entropy coder coupled with the output of the quantizer,
wherein the slice prediction residual downsampler is used to downsample a prediction residual of at least a portion of the image slice prior to transformation and quantization of the prediction residual.

2. The video encoder as defined in claim 1, wherein the image slice comprises video data in compliance with the International Telecommunication Union, Telecommunication Sector (ITU-T) H.264 standard.

3. The video encoder as defined in claim 1, wherein the slice prediction residual downsampler applies different downsampling operations for a horizontal direction and a vertical direction of the prediction residual.

4. The video encoder as defined in claim 1, wherein downsampling resolution used in the slice prediction residual downsampler is signaled by parameters in the image slice.

5. The video encoder as defined in claim 1, wherein the image slice is divided into image blocks, and a prediction residual is formed subsequent to an intra prediction for the image blocks.

6. The video encoder as defined in claim 5, wherein the intra prediction is performed using one of 8×8 and 32×32 prediction modes.

7. The video encoder as defined in claim 1, wherein the image slice is divided into image blocks, and a prediction residual is formed subsequent to an inter prediction for the image blocks.

8. The video encoder as defined in claim 1, wherein the slice prediction residual downsampler applies a downsampling operation to only one of a horizontal direction and a vertical direction of the prediction residual.

9. The video encoder as defined in claim 1, wherein the image slice is divided into macroblocks, and a reference index coded for an individual macroblock corresponds to whether the prediction residual for that individual macroblock will be downsampled.

10. The video encoder as defined in claim 1, wherein the video signal data corresponds to an interlaced picture, the image slice is divided into image blocks, and the slice prediction residual downsampler downsamples the prediction residual in one of a same mode as a current one of the coded image blocks, the same mode being one of a field mode and a frame mode.

11. A video encoder for encoding video signal data for an image, the video encoder comprising:
macroblock ordering means for arranging macroblocks corresponding to the image into at least two slice groups; and
a slice prediction residual downsampler for downsampling a prediction residual of at least a portion of an image slice prior to transformation and quantization of the prediction residual,
wherein said slice prediction residual downsampler is utilized to receive at least one of the slice groups for downsampling.

12. A video decoder for decoding video signal data for an image slice, the video decoder comprising:
a prediction residual upsampler for upsampling a prediction residual of the image slice; and
a combiner for combining the upsampled prediction residual with a predicted reference.

13. The video decoder as defined in claim 12, wherein the image slice comprises video data in compliance with the International Telecommunication Union, Telecommunication Sector (ITU-T) H.264 standard.

14. The video decoder as defined in claim 12, wherein the image slice is divided into macroblocks, and the video decoder further comprises Reduced Resolution Update (RRU) mode determining means connected in signal communication with prediction residual upsampler and responsive to reference indices at a macroblock level for determining whether the video decoder is in an RRU mode, and wherein a prediction residual for a current macroblock is upsampled by said prediction residual upsampler to decode the current macroblock.

15. The video decoder as defined in claim 12, wherein the slice prediction residual upsampler applies different upsampling operations for a horizontal direction and a vertical direction of the prediction residual.

16. The video decoder as defined in claim 12, wherein the upsampling resolution used in the slice prediction residual upsampler is signaled by parameters in the image slice.

17. The video decoder as defined in claim 12, wherein the image slice is divided into image blocks, and the prediction residual is formed subsequent to an intra prediction for the image blocks.

18. The video decoder as defined in claim 17, wherein the intra prediction is performed using one of 8×8 and 32×32 prediction modes.

19. The video decoder as defined in claim 12, wherein the image slice is divided into image blocks, and the prediction residual is formed subsequent to an inter prediction for the image blocks.

20. The video decoder as defined in claim 12, wherein the slice prediction residual upsampler applies an upsampling operation to only one of a horizontal direction and a vertical direction of the prediction residual.

21. The video decoder as defined in claim 12, wherein the image slice is divided into macroblocks, and a reference index coded for an individual macroblock corresponds to whether the prediction residual for that individual macroblock will be upsampled.

22. The video decoder as defined in claim 12, wherein the video signal data corresponds to an interlaced picture, the image slice is divided into image blocks, and said slice prediction residual upsampler upsamples the prediction residual in one of a same mode as a current one of the coded image blocks, the same mode being one of a field mode and a frame mode.

23. A method for encoding video signal data for an image slice, the method comprising the steps of:
downsampling a prediction residual of the image slice;
transforming the prediction residual; and
quantizing the prediction residual, wherein the step of downsampling is performed prior to the transforming or quantizing steps.

24. The method as defined in claim 23, wherein the image slice comprises video data in compliance with the International Telecommunication Union, Telecommunication Sector (ITU-T) H.264 standard.

25. The method as defined in claim 23, wherein said downsampling step comprises one of the steps of respectively applying different downsampling operations for a horizontal direction and a vertical direction of the prediction residual or applying a downsampling operation to only one of the horizontal direction and the vertical direction.

26. The method as defined in claim 23, wherein a downsampling resolution used for said downsampling step is signaled by parameters in the image slice.

27. The method as defined in claim 23, wherein the image slice is divided into image blocks, and the prediction residual is formed subsequent to an intra prediction for the image blocks.

28. The method as defined in claim 27, wherein the intra prediction is performed using one of 8×8 and 32×32 prediction modes.

29. The method as defined in claim 23, wherein the image slice is divided into image blocks, and the prediction residual is formed subsequent to an inter prediction for the image blocks.

30. The method as defined in claim 29, wherein the inter prediction is performed using 32×32 macroblocks and 32×32, 32×16, 16×32, and 16×16 macroblock partitions or 16×16, 16×8, 8×16, and 8×8 sub-macroblock partitions.

31. The method as defined in claim 23, wherein the image slice is divided into macroblocks, and the method further comprises the step of determining whether the prediction residual for an individual macroblock will be downsampled based on a reference index coded for that individual macroblock, the reference index corresponding to whether or not the prediction residual for that individual macroblock will be downsampled.

32. The method as defined in claim 23, wherein the image slice is divided into macroblocks, and the method further comprises the step of flexibly ordering the macroblocks in response to parameters in a picture parameters set.

33. The method as defined in claim 23, wherein the video signal data corresponds to an interlaced picture, the image slice is divided into image blocks, and said downsampling step downsamples the prediction residual in one of a same mode as a current one of the image blocks, the same mode being one of a field mode and a frame mode.

34. A method for decoding video signal data for an image slice, the method comprising the steps of:
upsampling a prediction residual of the image slice; and
combining the upsampled prediction residual to a predicted reference.

35. The method as defined in claim 34, wherein the image slice comprises video data in compliance with the International Telecommunication Union, Telecommunication Sector (ITU-T) H.264 standard.

36. The method as defined in claim 34, wherein the image slice is divided into macroblocks, and the method further comprises the step of determining whether the video decoder is in a Reduced Resolution Update (RRU) mode in response to reference indices at a macroblock level, and wherein said upsampling step comprises the step of upsampling a prediction residual for a current macroblock to decode the current macroblock.

37. The method as defined in claim 34, wherein said upsampling step comprises one of the steps of respectively applying different upsampling operations for a horizontal direction and a vertical direction of the prediction residual or applying an upsampling operation to only one of the horizontal direction and the vertical direction.

38. The method as defined in claim 34, wherein an upsampling resolution used for said upsampling step is signaled by parameters in the image slice.

39. The method as defined in claim 34, wherein the image slice is divided into image blocks, and the prediction residual is formed subsequent to an intra prediction for the image blocks.

40. The method as defined in claim 39, wherein the intra prediction is performed using one of 8×8 and 32×32 prediction modes.

41. The method as defined in claim 34, wherein the image slice is divided into image blocks, and the prediction residual is formed subsequent to an inter prediction for the image blocks.

42. The method as defined in claim 41, wherein the inter prediction is performed using 32×32 macroblocks and 32×32, 32×16, 16×32, and 16×16 macroblock partitions or 16×16, 16×8, 8×16, and 8×8 sub-macroblock partitions.

43. The method as defined in claim 34, wherein the image slice is divided into macroblocks, and the method further comprises the step of determining whether the prediction residual for an individual macroblock will be upsampled based on a reference index coded for that individual macroblock, the reference index corresponding to whether or not the prediction residual for that individual macroblock will be upsampled.

44. The method as defined in claim 34, wherein the video signal data corresponds to an interlaced picture, the image slice is divided into image blocks, and said upsampling step upsamples the prediction residual in one of a same mode as a current one of the image blocks, the same mode being one of a field mode and a frame mode.
